(19) United States
(12) Patent Application Publication
(10) Pub. No.: US 2024/0044423 A1
(43) Pub. Date: Feb. 8, 2024

(54) EQUIPMENT AND METHOD FOR RECOVERING FLEXIBLE PIPES WITHOUT THE USE OF SPECIAL VESSELS

(71) Applicant: PETRÓLEO BRASILEIRO S.A. – PETROBRAS, Rio de Janeiro (BR)

(72) Inventors: Henri FIORENZA DE LIMA, Vila Velha (BR); Gustavo GERALDO PAPPEN, Vitória (BR)

(21) Appl. No.: 18/258,530

(22) PCT Filed: Nov. 25, 2021
(86) PCT No.: PCT/BR2021/050516

§ 371 Date: Jun. 20, 2023

(30) Foreign Application Priority Data
Dec. 21, 2020 (BR) 10 2020 026297 1

(51) Int. Cl. F16L 1/20; F16L 1/16; B63B 27/08

(52) U.S. Cl. CPC F16L 1/20; F16L 1/166; B63B 27/08

(57) ABSTRACT

The present invention addresses to equipment for collecting flexible pipes without the use of special vessels, using less costly resources and which are not committed to not damaging such equipment during handling, since it is applied to pipes at the end of their useful life or that are already damaged. These types of pipes represent a major liability for some oil industry operators. The technology to be used, in phases of demobilization of fields or even for collecting pipes with no prospect of use, uses vessels with minimal adaptations that rely on the presence of collecting/launching wheels with a much smaller diameter when compared to the wheels used in conventional vessels or, alternatively, the launch of a special collection coil with its own traction means to make it possible to wind the abandoned pipes, in the same place where they are launched, with subsequent collection of the set and transshipment to the vessel itself.

### FIELD OF THE INVENTION

The present invention addresses to equipment for collecting flexible pipes without the use of special vessels, used in the field of oil exploration and production, mainly in vessels, platforms, rigs and production facilities, aiming at using less expensive resources, and which are not committed to not damaging the flexible pipes during handling, due to the non-reuse of such pipes.

### DESCRIPTION OF THE STATE OF THE ART

Typically, the naval resources employed in the launch and collection of subsea flexible pipes are quite expensive and with low availability. Whether for pipes that will be reused or for pipes that will be discarded, the usual resource (1) is the PLSV (Pipe Line Supply Vessel), a highly demanded resource that could be devoted only to noble activities that add value, such as pipe installation or relocation. The collection of pipes with a compromised useful life is part of the commitments assumed with the environmental agency when requesting installation and operating licenses, which is why these pipes are not simply abandoned in their locations. With the liability of pipes to be collected for disposal, either because of damage to their structure, or because they have already reached their operational useful life, or because they do not have the characteristics required by new projects, the need arises to use less costly resources that do not are committed not to damage such equipment during handling.

Document AU2014397727B2 addresses to a method for installing and removing a flexible line deployed between an offshore platform and a subsea structure positioned below the platform so that the relative movements are decoupled between the structures. The method comprises intermediate steps of support from the platform itself where the pipe is being installed, followed by the launching of the pipe and its interconnection in the corresponding subsea equipment. The system makes use of winches mounted on the platform and on the support vessel and storing the pipe on this second vessel. Furthermore, the document describes the relative movements of the vessel and the platform in order to make the proposed configuration viable. Despite also being used for the removal of flexible pipes, as well as the present invention, the document addresses to an alternative methodology for installing non-conventional configurations of subsea systems, but which use the same means that the proposed invention replaces.

Document PI 1003096-4 A2 addresses to a floating system for installation or removal of subsea equipment and structures. In one of its embodiments, the document was established with a floating system, like a barge, with an inverted U-shaped hull point, where one or more subsea structures or equipment are supported and transported, both in installation and removal operations. In another embodiment, it is possible to use two service boats that are designed and built to work with assembly or union, interconnected by a removable structure, resulting in a floating unique system, with a doubled load capacity and with greater availability of space for operations of transport or recovery of large subsea equipment, in addition to optimizing the onboard crew. This system may further have a removable structure with a drilling turret and perform well start operations, in addition to optimizing the onboard crew. One of the objectives disclosed in the document is the development of low-cost floating systems and vessels with high operational flexibility, so that they can be allocated both in long-term contracts and in opportunity contracts, with the capacity to perform a wide variety of operations of installation and intervention in subsea equipment. It is also an objective of the document to develop new concepts of floating systems, vessels and installation or recovery methods, which dispense with the use rigs or large boats dedicated to cargo launching operations, more flexible to different types of operation and with lower cost, being fundamental for the development of oil fields in deep waters. The document, despite addressing to a system for removing equipment from the sea, does not mention the use of coils and spools for winding pipes and storage on the vessel, nor the operation of collecting pipes.

Document WO2012056132A1 addresses to equipment for loading, transporting and installing flexible lines, such as pipes, control umbilicals or electrical cables, placed on board a floating support for installation at sea. More particularly, the purpose of the document is to provide a device for storing and handling flexible pipes on board laying vessels, which makes it possible to carry out laying operations at sea of said longer flexible pipes, and this is easier and faster; and, more particularly, what makes it possible to clear the ship deck more easily and quickly after completion of pipe-laying operations, and to re-install the device as necessary for a new pipe-lay, as easily and quickly as possible and with relatively small handling means, allowing, if necessary, on-site handling. Despite also disclosing equipment that performs the collection and winding of a flexible pipe, it does not mention the development of a special coil to be launched on the seabed and connected to the section to be collected, still addressing to the technology commonly used to which one seeks to offer an alternative.

The present invention addresses to equipment for the collection of flexible pipes without the use of special vessels, different from what is disclosed by documents of the state of the art.

### BRIEF DESCRIPTION OF THE INVENTION

The present invention addresses to equipment for collecting flexible pipes without the use of special vessels, using less costly resources and which are not committed to not damaging such equipment during handling, since it applies to pipes at the end of service life or that are already damaged. These types of pipes represent a major liability for some oil industry operators. The technology to be used, in phases of demobilization of fields or even for collecting pipes with no prospect of use, uses vessels with minimal adaptations that rely on the presence of collection/launch wheels with a much smaller diameter, when compared to the wheels used in conventional vessels, further having a space on the deck for the positioning of vertical spools activated hydraulically.

Such a collection may be carried out directly from the vessel deck or, alternatively, with the use of a special coil to be launched on the seabed and connected to the end of the section to be collected.

### Objectives of the Invention

The present invention aims at using less costly resources to collect subsea flexible pipes that will be discarded.

The present invention aims at using resources that are not committed to not damaging the flexible pipes during their handling.

The present invention aims at allowing the PLSV (Pipe Line Supply Vessel) to be used in other more noble activities, as it is a highly demanded and high-cost resource and much more sophisticated than that required for the operation in question.

It is further an objective of the invention to reduce the operating cost of collecting per kilometer of flexible pipes that have no prospect of reuse.

### BRIEF DESCRIPTION OF THE DRAWINGS

The present invention will be described in more detail below, with reference to the attached figures which, in a schematic way and not limiting the inventive scope, represent examples of the same. In the drawings, there are:

FIG. 1 illustrates a vessel with a simplified collection system (b), compared to a conventional vessel (a);

FIG. 2 details an even more sophisticated configuration, typically used for launching and collecting pipes;

FIG. 3 shows a typical tensioner used in launching and collecting flexible pipes;

FIG. 4 illustrates conventional coils for storage, transport and handling of flexible pipes;

FIG. 5 details the equipment for collecting flexible pipes on the seabed, proposed by this invention;

FIG. 6 details the auxiliary winding system of the equipment to be used both in a subsea and onshore way;

FIG. 7 details accessories for adapting the item shown in FIG. 6 to different pipe diameters;

FIG. 8 shows a typical flexible pipe connector, with a traction head installed.

FIG. 9 shows a stop collar to be used in cases of collecting pipes that have been cut at one of their ends and do not present one of the connectors at their ends.

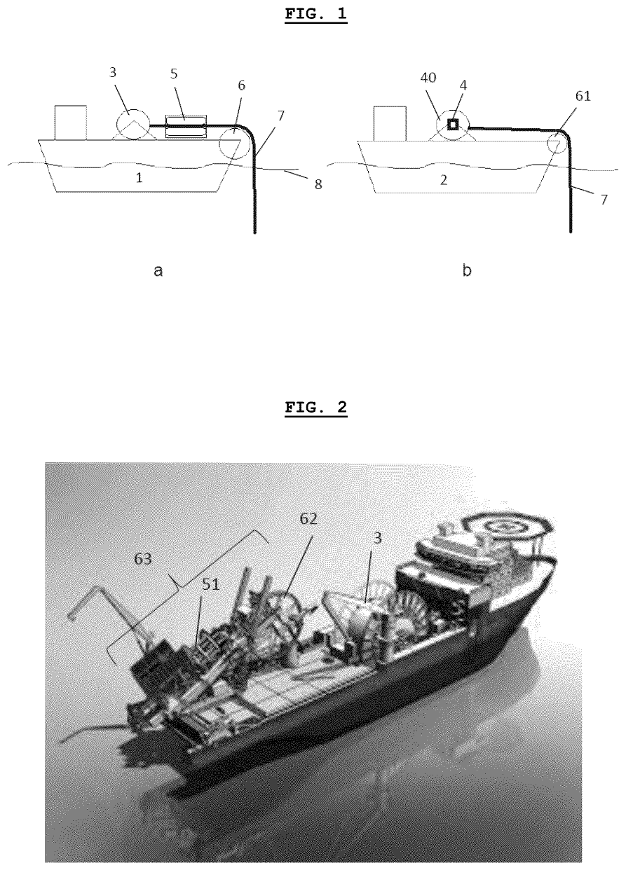

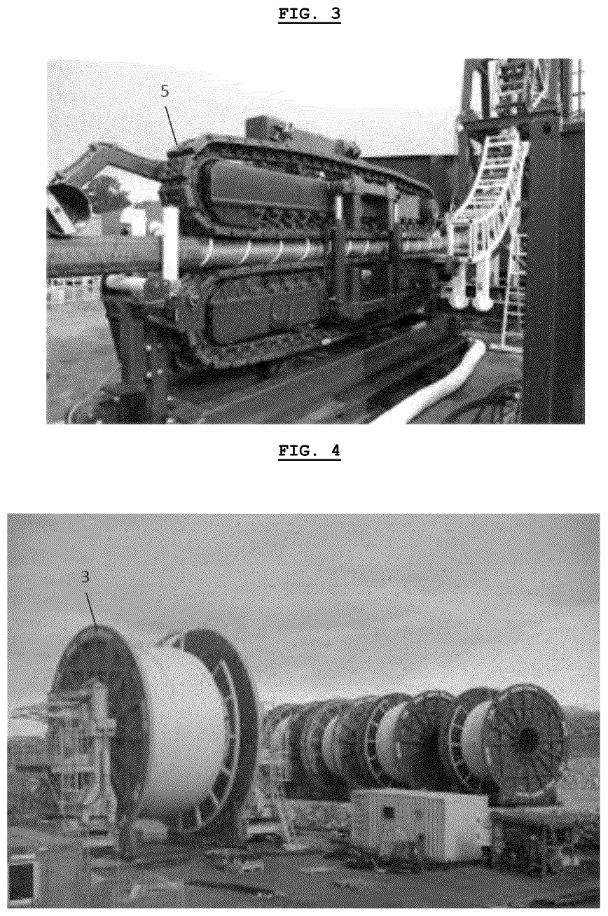

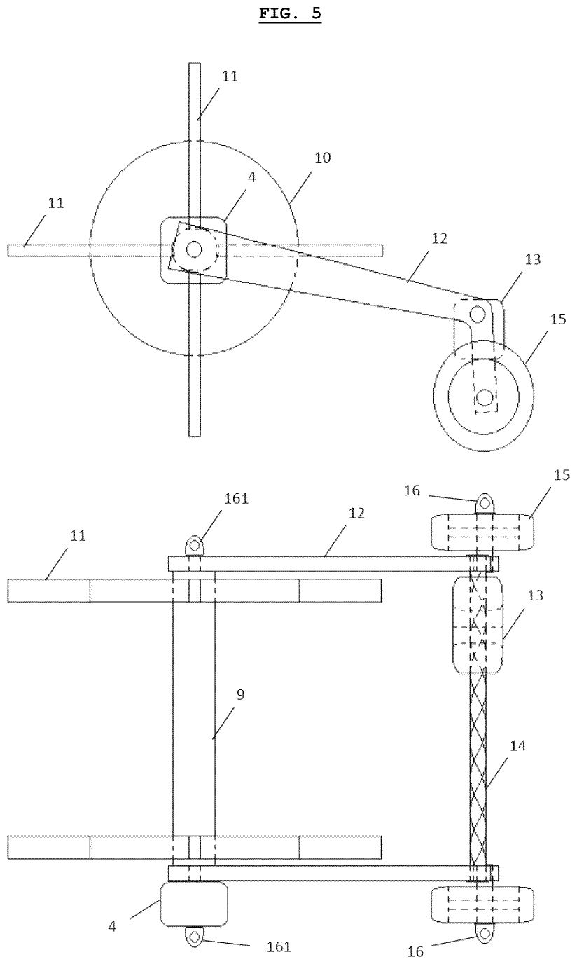

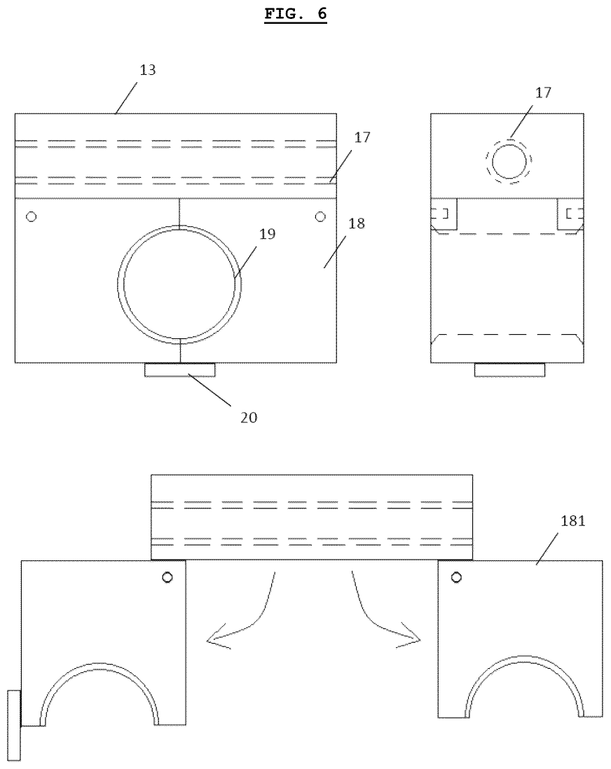

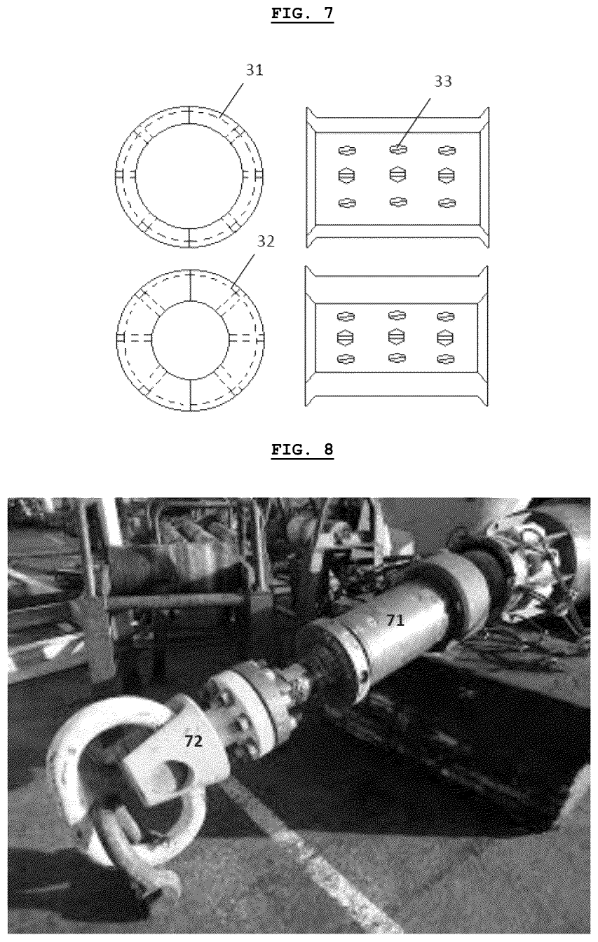

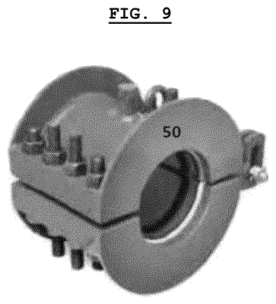

### DETAILED DESCRIPTION OF THE INVENTION

Preliminarily, it is emphasized that the description that follows will start from preferred embodiments of the invention. As will be apparent to any technician skilled on the subject, however, the invention is not limited to these particular embodiments, but rather to the scope defined in the claims.

The support vessel (2), with sufficient deck space to accommodate the vertical coil (40), aligned longitudinally with this vessel (2), to allow the launching of a cable, an accessory residing in the coil, when used onboard the vessel, connects to a traction head (72) (accessory for connection to the pipe to be collected), with the aid of an ROV (remotely operated subsea vehicle) made available by the vessel itself, preferably, or by a specific vessel, and pulls through the collection wheel (61) until the collected end arrives at the vertical coil (40); there is the connection of this end to the vertical coil (40) which starts to collect the pipe (7). The coil (40) shall be solidly interconnected to the deck of the support vessel (2), in view of the loadings observed in the collection. The hydraulic drive, through motors (4) and, possibly, gearboxes, shall be able to pull the pipe (7) to be collected until the vertical coil (40) or a set of similar coils is loaded.

The speed control is done in a similar way to the conventional one, but without the need to use tensioners (or “tracks”) (5) or other structures or equipment aimed at guaranteeing the integrity of the pipes (6, 62), during handling, equipment typical of conventional vessels (PLSVs) (1). Among these equipment, even more sophisticated structures are also observed, which are not limited to simple launch wheels, but tilting structures (63) provided with a launch pulley (62) with resident tensioners (51).

It is desirable to have the capacity and arrangement of the deck to accommodate more than one vertical coil (40), so that autonomy is increased, reducing navigation times for unloading material. The vertical coil (40) can be landed loaded or even be unloaded still on the deck of the support vessel (2) to the land.

This configuration is preferable for collecting pipes in shallow water, due to the low loads observed, in addition to being completely carried out in an emergent manner, above sea level (8).

Alternatively, due to the weight of the pipes and the simplicity of the support vessel (2), whether in shallow or deep waters, this same support vessel (2) may launch a special collection coil (9) on the pipe (7) resting on the seabed, close to one of its ends. This will be connected to the structure of the special collection coil (9), with the aid of cables present in the special collection coil (9) and with the aid of an ROV, which guides the pipe (7) to pass through an auxiliary winding mechanism (13), which acts as a guide and which, with the aid of a shaft (14), allows the correct alignment and, consequently, the winding of the pipe, taking full advantage of the winding capacity of the special collection coil (9). The special collection coil (9) must have radial rods (11) embedded in a circular structure of reinforcement (10), typically observed in conventional storage coils (3).

The auxiliary winding mechanism (13) has a hole with cavities (17) that work together with the transverse rod (14), causing, with each complete turn of the coil (9), the auxiliary winding mechanism (13) is moved laterally the equivalent of one diameter of the pipe (7) so that, on the next turn of the coil, the pipe is wound in a lateral position on the last turn.

The auxiliary winding mechanism (13) must have a split component (18) to embrace the pipe (7), aligning its path with what is desired for a correct winding. These split components (18) must have facilities to be operated by the ROV, for opening (181) and closing, as well as locking through a latch (20), which will keep the parts of the split component (18) together.

If it is necessary to adapt the auxiliary winding mechanism (13) to different diameters, an insert (31, 32) can be mounted in the cavity (19), through fasteners (33). The diameter of the cavity (19) must be compatible with the maximum outer diameter of the pipe (7), in the range of 35 cm. Each insert (31, 32) must meet a range of outer diameters that allow the passage of the pipe (7) through the same and the fixation of the end connector (71) when the collection is finished. The smallest expected diameters are in the range of 10 cm.

The radial rods (11) must have a spring-loaded or hydraulically actuated telescopic configuration, so that they can extend as the special collection coil (9) is filled by the collected pipe. The reason why an adapted conventional coil (3) is not used, where the circular reinforcement structure (10) assumes the entire radial extension comprised by the useful volume of such coil, is that it would have a high probability of getting stuck, jamming on the seabed. The reinforcing circular structure also serves as a guide for the radial rods (11). Such radial rods (11) act as stops to stabilize the positioning of the pipe (7) during and after collection. The curvature of the surface of the special collection coil (9), on which the pipe will be deposited, can be much more accentuated than that observed in a conventional structure, that is, while a conventional coil (3) has an internal diameter in the order from 2 to 3 meters, so that there is no damage to the pipe when being coiled, the special collection coil (9) of the present invention could have an internal diameter of around 1 meter, since there are no requirements of not damaging the pipe (7) to be collected. This also increases the carrying capacity thereof.

For collecting the pipe (7), the hydraulic motor (4), residing in the special collection coil (9), is fed through an umbilical cable consisting of hydraulic hoses that will allow the circulation of fluids in both directions (surface/motor and motor/surface), driving the movement of the special collection coil (9) and keeping the pipe pulled, for a correct winding and collection of the same. The hydraulic motor (4) may have a set of valves for better speed control, and assist in the routing for other hydraulic components that may be used in the special collection coil (9), such as, for example, the radial rods (11).

The rotation of the transverse rod (14) is coupled with the rotation of the shaft of the special collection coil (9) through a timing belt, allowing to configure the rotation of the transverse rod (14) according to the diameter of the pipe to be to be collected and the step of translating the auxiliary winding mechanism (13). Different configurations of grooves can be adopted in the transverse rod (14) in order to adapt to different ranges of outer diameters of the pipes (7) to be collected. The vast majority of pipes to be collected have diameters in the range of 4 inches to 6 inches (10.16 cm to 15.24 cm), requiring a reduced number of configurations of the transverse rod (14).

A clutch system is desirable, which will allow the relative movement of the inner part of the coil (9) in relation to the radial rods (11) in order to maintain the tensioning of the pipe (7).

In the case of hydraulic actuation of the radial rods (11), it is necessary to provide for a greater number of hydraulic hoses in the umbilical or to provide for the shipping a set of hydraulic directional valves in the block that contains the motor (4), which in this case would incorporate, in addition to the hydraulic motor, a hydraulic circuit to actuate the motor itself and the cylinders that will act on the rods (11).

To correct the position of the coil in order to follow the path of the pipe (7), steel cables from the vessel (2) shall be connected to the eyes (16). Such eyes are attached to the longitudinal rods (12) and to the axle of the wheels (15), which components aid in the displacement of the special collection coil (9) on the seabed. The wheels (15) consist of a metallic structure and solid tires, due to the need to operate in great depths. Such tires are wide enough to distribute the pressure exerted on the seabed, so that they do not get stuck, making their displacement and operation difficult as a whole.

With the aid of cables, the ROV locks the traction head (72) or, in the case of its absence, the connector (71) of the first end, in the special collection coil (9), to start the winding, with the driving of the hydraulic motor (4). The pipe (7) must be accommodated inside the auxiliary winding mechanism (13), which will be assembled around the pipe (7), with the aid of the ROV. After this assembly, the vessel (2) assists in the direction of displacement of the special collection coil (9). Upon reaching the connector (71) of at the second end, if there is a second connected section, the split component (18) shall be opened by unlocking the lock (20) and, soon after, closed to proceed with the collection of the pipe (7), until its complete collection. There will be maintenance of the tensioning of the pipe (7), after being collected, with the end connector (71) being forced against the cavity (19) or one of its inserts (31, 32).

To enable the locking of pipes that do not contain the end connector (71) at the second end, which is common in pipes that have suffered cuts, it is necessary to install a stop collar (50) by the ROV.

At the end of the collection, the end connector (71) relative to the second end of the pipe (7) or the stop collar (50) is fixed to the split component (18), preventing the pipe (7) from unrolling during transfer to the ship, with the aid of a crane or A-Frame. The special collection coil (9) is pulled to the deck of the vessel (2), being suspended by the set of eyes (16 and 161), and the pipe (7) can be transferred to a conventional coil (3), for reuse of the special collection coil (9). For such a suspension, all eyes (16 and 161) must be used, that is, the two points containing eyes (16) and two points containing eyes (161).

The capacity of the special collection coil (9) is related to the load capacity of the equipment installed in the naval resource. If there are two or more sections connected together, the equipment must be able to collect up to the second connector of the last section, passing through the auxiliary winding mechanism (13), which serves as a guide for the pipe (7). The collection methodology can provide for the unloading of the special collection coil (9) on board the vessel itself or in an auxiliary vessel for reuse of the coil. The means for activating the accessories of the special collection coil (9) must be easy to operate by ROV.

For the equipment to be used correctly, it is recommended to use the actions, given the sequence in the following steps:
Interconnecting the traction head (72) of the end connector (71) to the special collection coil (9) with the aid of the ROV;
Accommodating the tubular body of the pipe (7) inside the auxiliary winding mechanism (13), which will be assembled around the pipe (7) with the aid of the ROV;
Pulling the special collection coil (9), with the vessel (2), in the collection direction of the pipe (7);
Rotating the special collection coil (9) to collect the pipe (7) as the boat moves, with the rods (11) stuck in the sand, wherein the special collection coil (9) collects the pipe through the hydraulic drive of the motor (4) until the coil is fully loaded.

Alternatively, the auxiliary winding mechanism (13) shall be disarmed and rearmed until the end of the collection of the pipe (7) due to the passage of connectors that interconnect different sections, if any.

1. EQUIPMENT FOR COLLECTING FLEXIBLE PIPES WITHOUT THE USE OF SPECIAL VESSELS, comprising:
at least one support vessel with at least one vertical coil, the vertical coil being interconnected to the deck of this same vessel and aligned longitudinally with its deck;
an ROV and means for controlling the same, and
a reduced diameter collection wheel.

2. THE EQUIPMENT according to claim 1, wherein the vertical coil collects a flexible pipe through a hydraulic drive of the motor.

3. THE EQUIPMENT according to claim 2, wherein the speed control, during the hydraulic drive of the motor, eliminates the use of tracks or other structures or equipment aimed at guaranteeing the integrity of the pipes during handling.

4. THE EQUIPMENT according to claim 1, wherein the support vessel has the capacity and deck arrangement to accommodate more than one coil.

5. THE EQUIPMENT according to claim 1, wherein the support vessel launches a special collection coil near one of the ends of the pipe that rests on the seabed.

6. THE EQUIPMENT according to claim 5, wherein the special collection coil comprises a circular reinforcement structure, and radial rods without circular reinforcements.

7. THE EQUIPMENT according to claim 5, wherein the special collection coil has an internal diameter smaller than the conventional one.

8. THE EQUIPMENT according to claim 5, wherein the radial rods allow traction on the longitudinal rods of the special collection coil, forcing its rotation to change direction, following the route of the pipe to be collected.

9. THE EQUIPMENT according to claim 5, wherein the radial rods allow the stabilization of the positioning of the pipe during and after the collection.

10. THE EQUIPMENT according to claim 5, wherein the special collection coil has an auxiliary winding mechanism coupled to ensure proper positioning and winding of the pipe on the special collection coil; a support system and mooring points consisting of eyes and, with an onboard hydraulic system consisting of the motor to allow the winding of the pipe in the special collection coil.

11. THE EQUIPMENT according to claim 10, wherein the hydraulic motor alternatively has a set of valves to assist the use of radial rods.

12. THE EQUIPMENT according to claim 10, wherein it uses of a timing belt that joins the shaft of the special collection coil with the transverse rod.

13. THE EQUIPMENT according to claim 10, wherein the transverse rod has different grooves to be able to translate the auxiliary winding mechanism according to the outer diameter of the pipe to be collected.

14. A METHOD FOR COLLECTING FLEXIBLE PIPES WITHOUT THE USE OF SPECIAL VESSELS, using the special collection coil as defined in claim 1, comprising:
interconnecting the traction head of the end connector to the special collection coil with the aid of the ROV;
accommodating the section inside the auxiliary winding mechanism that will be assembled around the pipe with the aid of the ROV;
pulling the special collection coil, with the vessel, in the collection direction of the pipe; and
rotating the special collection coil to collect the pipe as the boat moves, with the rods stuck in the sand.

15. THE METHOD according to claim 14, wherein the special collection coil collects the pipe through the hydraulic drive of the motor until the special collection coil is fully loaded.

16. THE METHOD FOR according to claim 15, wherein the ROV aids to connect the cables for collecting the pipe.

17. THE METHOD according to claim 14, wherein that, at the end of the collection, the end connector or stop collar is fixed and the special collection coil is pulled onto the deck of the vessel through the eyes.
